(19) United States
(12) Patent Application Publication
(10) Pub. No.: US 2014/0344447 A1
(43) Pub. Date: Nov. 20, 2014

(54) METHOD AND APPARATUS FOR EXECUTING APPLICATION

(71) Applicant: Samsung Electronics Co., Ltd., Suwon-si (KR)

(72) Inventors: Kyung-sun CHO, Seoul (KR); Young-il CHOI, Seoul (KR)

(73) Assignee: Samsung Electronics Co., Ltd., Suwon-si (KR)

(21) Appl. No.: 14/267,130

(22) Filed: May 1, 2014

(30) Foreign Application Priority Data
May 15, 2013 (KR) 10-2013-0055277

(51) Int. Cl. H04L 12/26

(52) U.S. Cl. CPC H04L 43/10
USPC 709/224

(57) ABSTRACT

A method of executing an application in a terminal in a distributed fashion is provided. The method includes monitoring an execution environment of the application, selecting a module to be offloaded based on a result of the monitoring, transmitting information on the selected module to an offload server, and executing the application in a distributed fashion by cooperating with the offload server.

### CROSS-REFERENCE TO RELATED APPLICATION(S)

This application claims the benefit under 35 U.S.C. §119(a) of a Korean patent application filed on May 15, 2013 in the Korean Intellectual Property Office and assigned Serial No. 10-2013-0055277, the entire disclosure of which is hereby incorporated by reference.

### TECHNICAL FIELD

The present disclosure relates to methods and apparatuses for executing an application. More particularly, the present disclosure relates to methods and apparatuses for executing an application by processing some application codes on an external device.

### BACKGROUND

The performance of software and hardware on terminals, such as cellular phones, is rapidly developing. However, applications executed by the terminals may also require high software requirements, and hardware limitations, such as battery power, are also problematic.

Thus, there is an increased demand for application module offloading for processing a portion of an application by an external device such as a cloud server, receiving, by a terminal, a result of the processing, and executing the application by the terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for executing an application in a terminal in an optimal environment according to an application execution environment including a characteristic of the terminal, a resource state of the terminal, a characteristic of the application, a network state, and/or the like.

Additional aspects will be set forth in part in the description which follows and, in part, will be apparent from the description, or may be learned by practice of the presented embodiments.

In accordance with an aspect of the present disclosure, a method of executing an application in a terminal in a distributed fashion is provided. The method includes monitoring an execution environment of the application, selecting a module to be offloaded based on a result of the monitoring, transmitting information on the selected module to an offload server, and executing the application in a distributed fashion by cooperating with the offload server.

The application may be an application executable in a distributed fashion, which is restructured according to at least one execution environment condition by profiling the same application under the at least one execution environment condition and referring to a result of the profiling.

The execution environment may include at least one of a hardware specification, a software specification, a battery state, a network state, and a resource state of the terminal.

The executing of the application in a distributed fashion may include executing one of two or more code sets separated based on the result of the profiling.

The application may be an application code set in which at least one execution mode is determined according to the at least one execution environment condition by referring to the result of the profiling, and a separated code for offloading a module by setting the at least one execution mode as a separated condition is inserted.

The selecting of the module to be offloaded may include selecting one of the at least one execution mode.

In accordance with another aspect of the present disclosure, a method of executing an application in a server in a distributed fashion is provided. The method includes receiving information on a module to be offloaded from a terminal, selecting the module to be offloaded based on the received information, and executing the application in a distributed fashion by cooperating with the terminal.

The application may be an application executable in a distributed fashion, which is restructured according to at least one execution environment condition by profiling the same application under the at least one execution environment condition and referring to a result of the profiling.

The at least one execution environment condition may include at least one of a hardware specification, a software specification, a battery state, a network state, and a resource state of the terminal.

The executing of the application in a distributed fashion may include executing one of two or more code sets separated based on the result of the profiling.

The application may be an application code set in which at least one execution mode is determined according to the at least one execution environment condition by referring to the result of the profiling, and a separated code for offloading a module by setting the at least one execution mode as a separated condition is inserted.

The information on the module to be offloaded may indicate one of the at least one execution mode.

In accordance with another aspect of the present disclosure, a terminal for executing an application in a distributed fashion is provided. The terminal includes a monitoring unit configured to monitor an execution environment of the application in the terminal, an offloading module selection unit configured to select a module to be offloaded based on a result of the monitoring, a manager unit configured to transmit information on the selected module to an offload server, and a distribution execution unit configured to execute the application in a distributed fashion by cooperating with the offload server.

The application may be an application executable in a distributed fashion, which is restructured according to at least one execution environment condition by profiling the same application under the at least one execution environment condition and referring to a result of the profiling.

The execution environment may include at least one of a hardware specification, a software specification, a battery state, a network state, and a resource state of the terminal.

The application may include at least one application code set separated according to the execution environment condition based on the profiling result.

The terminal may further include a terminal code storage unit configured to store application codes, wherein the distribution execution unit may execute one of two or more code sets separated based on the result of the profiling.

The application may be an application code set in which at least one execution mode is determined according to the at least one execution environment condition by referring to the result of the profiling, and a separated code for offloading a module by setting the at least one execution mode as a separated condition is inserted.

The offloading module selection unit may select one of the at least one execution mode.

In accordance with another aspect of the present disclosure, a server for executing an application in a distributed fashion is provided. The server includes a manager unit configure to receive information on a module to be offloaded from a terminal and to select the module to be offloaded based on the received information, and a distribution execution unit configured to execute the application in a distributed fashion by cooperating with the terminal.

The application may be an application executable in a distributed fashion, which is restructured according to at least one execution environment condition by profiling the same application under the at least one execution environment condition and referring to a result of the profiling.

The at least one execution environment condition may include at least one of a hardware specification, a software specification, a battery state, a network state, and a resource state of the terminal.

The server may further include a server code storage unit configured to store application codes, wherein the distribution execution unit may execute one of two or more code sets separated based on the result of the profiling.

The application may be an application code set in which at least one execution mode is determined according to the at least one execution environment condition by referring to the result of the profiling, and a separated code for offloading a module by setting the at least one execution mode as a separated condition is inserted.

The distribution execution unit may change the at least one execution mode based on the received information.

In accordance with another aspect of the present disclosure, a non-transitory computer-readable storage medium having stored therein program instructions is provided, which when executed by a computer, perform the methods disclosed herein.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual diagram of a module offloading system according to an embodiment of the present disclosure;

FIG. 2 is a flowchart illustrating a method of restructuring an arbitrary application to an application executable in a distributed fashion by changing a module to be offloaded according to an execution environment according to an embodiment of the present disclosure;

FIG. 3 illustrates restructuring of application codes into a plurality of code sets executable in a distributed fashion according to execution environment conditions according to an embodiment of the present disclosure;

FIG. 4 illustrates selection and execution of one code set according to a result of monitoring an execution environment during static offloading according to an embodiment of the present disclosure;

FIG. 5 illustrates definition of an execution mode for dynamic offloading according to an embodiment of the present disclosure;

FIG. 6 illustrates an application code set for dynamic offloading in which a module to be offloaded is changed according to an execution environment during the execution of an application by inserting a separated code according to an embodiment of the present disclosure;

FIG. 7 is a flowchart illustrating a method of executing an application by changing a module to be offloaded according to an execution environment in a terminal, according to an embodiment of the present disclosure;

FIG. 8 is a flowchart illustrating a method of executing an offloaded module by cooperating with a terminal in an offload server according to an embodiment of the present disclosure;

FIG. 9 is a signaling diagram of static offloading in which an application is executed in a distributed fashion by selecting one of a plurality of code sets according to an execution environment according to an embodiment of the present disclosure;

FIG. 10 is a signaling diagram of static offloading in which an application is executed in a distributed fashion by selecting one of a plurality of code sets according to an execution environment according to an embodiment of the present disclosure;

FIG. 11 is a signaling diagram of dynamic offloading in which an application is executed in a distributed fashion by changing an offloaded module according to an execution environment during execution of the application according to an embodiment of the present disclosure;

FIG. 12 is a signaling diagram of dynamic offloading in which a web application is executed in a distributed fashion according to an embodiment of the present disclosure; and

FIG. 13 is a block diagram of a terminal and an offload server for executing an application in a distributed fashion by offloading an application module according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

When it is described throughout the specification that a certain part is “connected” to another part, it should be understood that the certain part may be “directly connected” to another part or “electrically connected” to another part by an interposing another part there between. In addition, when a certain part “includes” a certain component, this indicates that the part may further include another component instead of excluding another component unless there is different disclosure.

As used herein, the term “and/or” includes any and all combinations of one or more of the associated listed items. Expressions such as “at least one of,” when preceding a list of elements, modify the entire list of elements and do not modify the individual elements of the list.

Hereinafter, various embodiments of the present disclosure will be described with reference to the accompanying drawings.

A module in an application according to an embodiment of the present disclosure indicates a code set for performing a function, a thread, a class of the application, or the like.

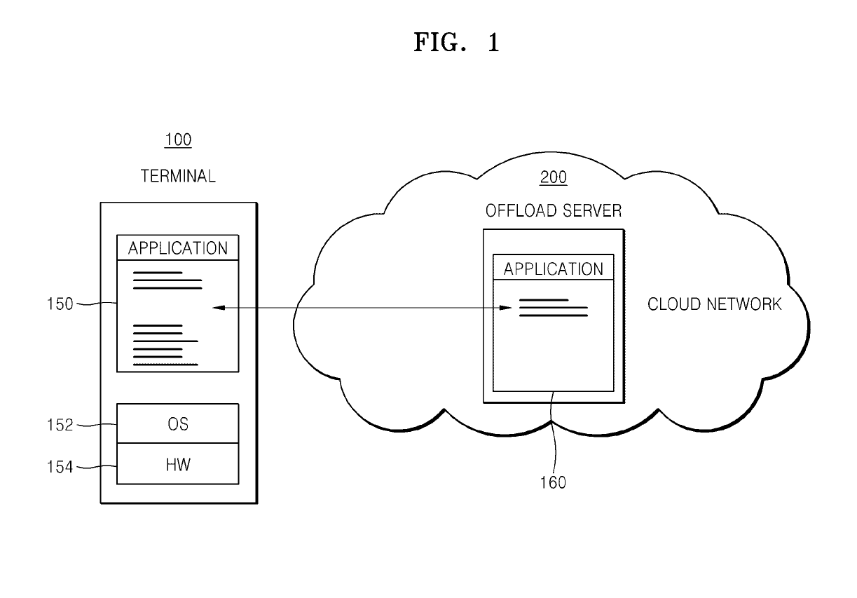

FIG. 1 is a conceptual diagram of a module offloading system according to an embodiment of the present disclosure.

Referring to FIG. 1, the module offloading system according to an embodiment of the present disclosure includes a terminal 100 and an offload server 200.

The terminal 100 is a device capable of executing an application 150. The terminal 100 may execute the entire application 150 or execute the application 150 in a distributed fashion by cooperating with an external device.

The terminal 100 may be a device, such as a computer, a mobile device, a TV, or the like, which may be connected to a wired/wireless network. The mobile device may be a portable device, such as a cellular phone, a smart phone, a Personal Digital Assistant (PDA), a Portable Multimedia Player (PMP), or a navigation device, etc. The terminal 100 may include an Operating System (OS) 152 and hardware (WH) 154.

The offload server 200 is a server capable of executing an application 160. The offload server 200 may execute the entire application or execute the application in a distributed fashion by cooperating with the terminal 100.

The offload server 200 may be a specific server for executing an application by cooperating with the terminal 100 or a server which includes various virtual machines and can perform cloud computing. In addition, the offload server 200 may be a single server or a set of servers. The offload server 200 is not limited to a server and may be any of various types of external devices capable of executing an application in a distributed fashion.

An application may be restructured so that some modules thereof can be executed in the offload server 200. The application may be restructured so that some modules thereof can be executed in a distributed fashion by an external device by being offloaded to the external device according to an execution environment.

An offloaded module may be called in a Remote Procedure Call (RPC) method. Thus, when the terminal 100 calls an offloaded module, a module located in the offload server 200 may be called. The offload server 200 executes an offload module in response to a module call performed by the terminal 100, and a result of the execution is returned to the terminal 100. The terminal 100 may execute other code based on the module execution result returned to the terminal. In addition, the offload server 200 may call a module in the terminal 100.

The terminal 100 may reduce the use of its resources by offloading some modules, which may be typically executed in the terminal 100, to an external device, and accordingly, an optimal user experience of the application may be provided to a user.

To provide an optimal application execution state when an application is executed, a module to be offloaded may vary according to an application execution environment condition, such as a module characteristic of the application, a hardware or software specification of the terminal 100, a resource state of the terminal 100, a battery state, and/or a network state.

Thus, to obtain the module characteristic of the application having a module which uses a large amount of resources of the terminal 100, it is determined in advance as to whether battery consumption exceeds a predetermined amount and whether data traffic is large.

In addition, the module to be offloaded according to an application execution environment may be determined in advance through profiling according to the application execution environment.

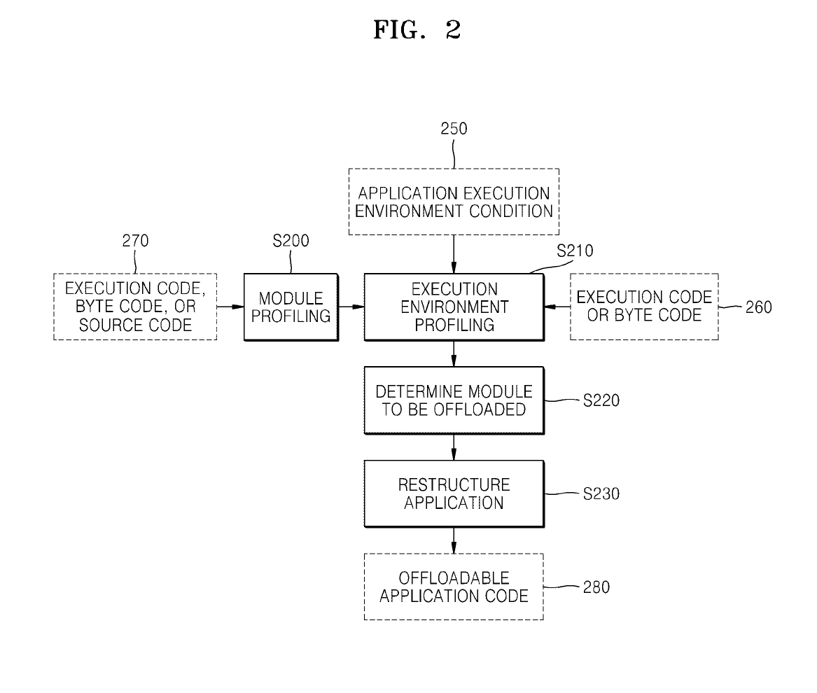

FIG. 2 is a flowchart illustrating a method of restructuring an arbitrary application into an application executable in a distributed fashion by changing a module to be offloaded according to an execution environment according to an embodiment of the present disclosure.

The method of restructuring the application to an offloadable application 280 may include a module profiling operation S200, an execution environment profiling operation S210, an offloading module determining operation S220, and an application restructuring operation S230.

The module profiling operation S200 is an operation of analyzing a module characteristic of an application. The analyzed module characteristic may be a criterion for offloading a module when the application is tested in the execution environment profiling operation S210.

For example, whether a module is a high-load module using a large amount of resources of the terminal 100 may be determined. A module, which uses a Central Processing Unit (CPU) or a Random Access Memory (RAM) frequently to perform Three-Dimensional (3D) graphic processing or the like, may be determined as a high-load module. The high-load module may be determined as a module which should be offloaded based on a test initiated when resources of the terminal 100 are lacking.

For example, whether a module requires large data traffic between modules may be determined. When some modules requiring large data traffic between other modules are offloaded, since data between modules moves through communication with an external device, the performance may be degraded due to a time delay. Thus, it may be determined that modules requiring large data traffic between modules are offloaded all together or performed in the terminal 100.

For example, whether a module requires large data traffic with an external device may be determined. It may be determined that a module frequently accessing an external Database (DB) is a module requiring large data traffic. Thus, the module frequently accessing an external DB may be determined as a module to be offloaded based on a test initiated when a network state of the terminal 100 is degraded.

For example, a runtime duration of a module, the number of CPU cycles of the module, or the like may be determined. When the runtime duration of the module or the number of CPU cycles of the module is large, the module may be selected as a module to be offloaded based on a test initiated when a battery state of the terminal 100 is equal to or less than a reference value.

For example, whether specific hardware or software is required to execute a module may be determined. The module requiring the specific hardware or software may be selected as a module to be offloaded based on a test initiated when the terminal 100 does not support the specific hardware or software.

For example, whether the performance of a module is expected to degrade when the module is offloaded from the terminal 100 to the offload server 200 may be determined. When the module is a module using hardware included in only the terminal 100 or a module related to a user interface, the module may be determined as a module having a performance which is expected to degrade during offloading. In addition, when a module of the application, which is executed on a virtual machine, calls a native code of the terminal 100 or shares a native state, the module may be determined as a module having a performance which is expected to degrade during offloading.

The module profiling operation S200 may be performed by a developer at an application level using an execution code, byte code, or source code 270. For example, determination on whether a module calls a native code of the terminal 100 or uses hardware of the terminal 100 or determination on whether the module is a high-load module using a large amount of resources or a module requiring large data traffic with an external device may be determined by the developer. The notations on modules may be identified in the compiling in the execution environment profiling operation S210 and may be used as information for determining a module to be offloaded. In addition, the module profiling operation S200 may measure inter-module data traffic, a resource usage amount, a run time, the number of CPU cycles, and a battery consumption amount of each module while directly executing an execution code or a byte code 260 in the terminal 100 and may derive a characteristic of the module based on the measured values.

The module profiling operation S200 may be automatically performed by a module analysis tool. The module analysis tool may automatically derive data of each module while executing the application in the terminal 100.

The execution environment profiling operation S210 is an operation of testing the performance of the application according to an application execution environment condition 250.

An offloading scenario in which the application exhibits the optimal performance in various execution environments may not be determinable with only the module profiling operation S200.

For example, even though the application is executed by offloading a high-load module when resources of the terminal 100 are lacking, if a data movement amount between the offloaded module and a module located in the terminal 100 is large, the performance of the application may degrade when a network state is poor.

For example, even though the application is executed by offloading a module having large data traffic with an external device when a network state of the terminal 100 is less than a reference value, if a time delay due to data movement between an offloaded module and a module located in the terminal 100 is large, the performance of the application may degrade.

Thus, an optimal offloading scenario may be determined by testing the application in various execution environment conditions.

In the execution environment profiling operation S210, an execution environment condition of the application may be a set of a plurality of individual conditions. In addition, execution environment conditions, such as a resource state, a network state, and a battery state may be digitized. In addition, a module to be offloaded in one execution environment condition may be changed and tested, and the determination of which module is to be offloaded and tested may be made based on the module characteristic information derived in the module profiling operation S200.

For example, the execution environment condition may be a resource state. Profiling may be performed when the terminal 100 satisfies a specification that is lower than that required for the execution of the application or when the terminal 100 satisfies the specification required for the execution of the application but lacks resources due to execution of another application. Alternatively, the profiling may be performed for a specific terminal product. According to the profiling based on the lack of resources, the performance of the application may be tested by offloading a high-load module.

For example, the execution environment condition may be a network state of the terminal 100. Profiling may be performed when the terminal 100 uses a Third-Generation (3G) network or when the network state is less than a reference value. According to the profiling on the network state, the performance of the application may be tested by offloading a module having a large amount of traffic with an external device.

For example, the execution environment condition may be a battery state of the terminal 100. Profiling may be performed when a battery state of the terminal 100 has a voltage that is less than a reference value. According to the profiling on the battery state, the performance of the application may be tested by offloading a module having a long runtime duration or a large CPU usage amount.

The execution environment profiling operation S210 may be automatically performed by a system by receiving the byte code or the execution code of the application.

In the offloading module determining operation S220, the module to be offloaded according to each execution environment condition is determined by referring to the information derived in the module profiling operation S200 and the execution environment profiling operation S210.

For example, a module to be offloaded is selected as the application that may exhibit optimal performance based on the information derived through the profiling in each execution environment condition.

The application restructuring operation S230 is an operation of restructuring the application so that the module determined in the offloading module determining operation S220 is offloaded when the application is executed.

According to an embodiment for the application restructuring operation, a module to be offloaded may be separated from the application and restructured as one code set for one execution environment condition (static offloading). Thus, a single application code set is generated for each execution environment condition.

Codes to be executed in the offload server 200 (server code) from among a code set make up a module offloaded from original application codes. Codes to be executed in the terminal 100 (terminal code) from among the code set are codes that remain after excluding the offloaded module from the original application codes. The original application codes are restructured so that each code can remotely call each other module.

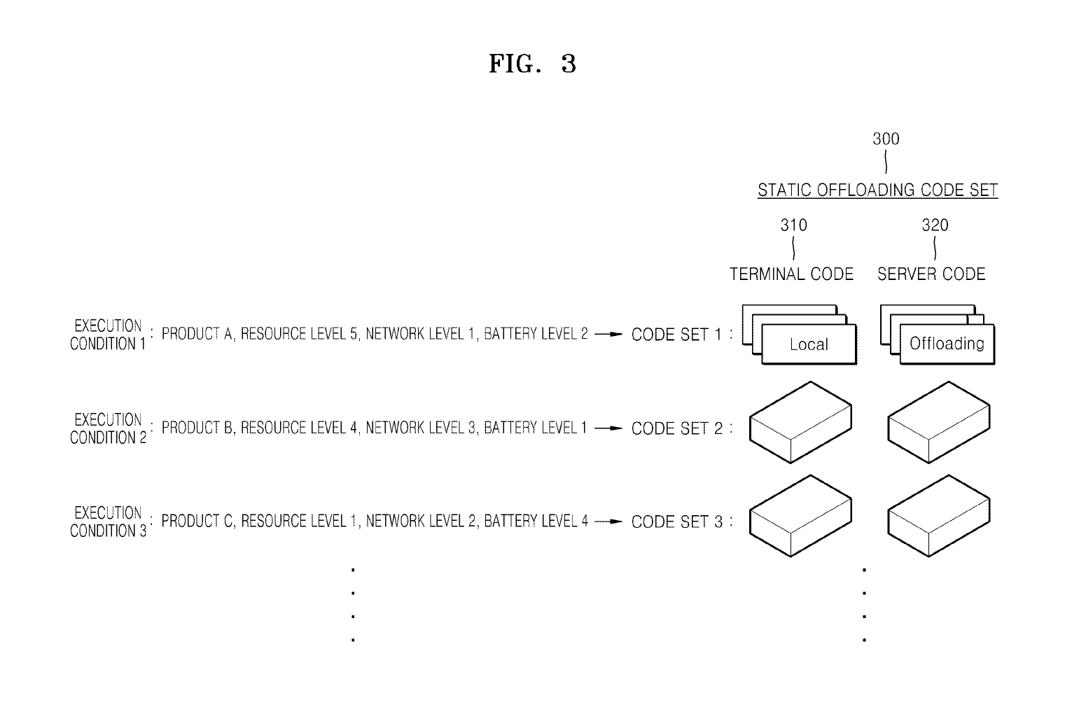

FIG. 3 illustrates restructuring of application codes into a plurality of code sets executable in a distributed fashion according to execution environment conditions according to an embodiment of the present disclosure.

Referring to in FIG. 3, when a code set 1 exhibits optimal performance in an execution environment condition 1 obtained by profiling an execution environment, such as, a terminal product of A, a resource level of 5, a network level of 1, and a battery level of 2, the code set 1 corresponding to the execution environment condition 1 may be generated.

A code set, i.e., static offloading code set 300, may include not only an execution code but also a source code 270. Codes to be executed in the offload server 200, i.e., server code 320, from among a code set make up a module offloaded from original application codes. Codes to be executed in the terminal 100, i.e., terminal code 310, from among the code set are codes that remain after excluding the offloaded module from the original application codes. In addition, the code set may have a format depending on the development language used, for example, several class files for Java or one binary file for C or C++.

The application restructuring operation S230 may be automatically performed by the system by receiving the byte code or the execution code of the application.

In the static offloading, one of a plurality of application code sets is selected according to a result of the execution environment monitoring before the application is executed.

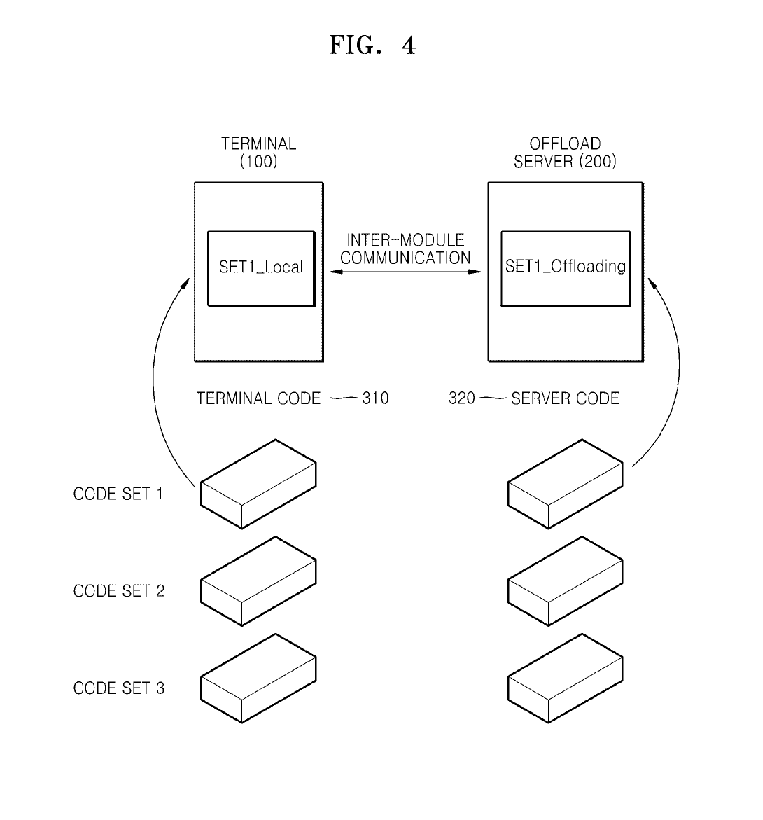

FIG. 4 illustrates selection and execution of one code set according to a result of monitoring an execution environment during static offloading according to an embodiment of the present disclosure.

Referring to FIG. 4, the terminal 100 monitors an execution environment before the application is executed. The terminal 100 may select and execute a code set suitable for the execution environment before the execution of the application based on a result of the monitoring. The offload server 200 may also receive information on the selected code set from the terminal 100 and execute server code corresponding to the selected code set.

The code set may be stored in the terminal 100 and the offload server 200 before the application is executed.

An offloaded module and a module executed in the terminal 100 may communicate with each other through RPC. Thus, the original application code may be restructured as an offloadable application by using an implementation of each protocol so that RPC or Extensible Markup Language (XML)-RPC communication can be performed between remote modules.

For example, when the application is written in a Java language, each module may be reedited as server classes of Java Remote Method Invocation (RMI), and an original module call code may be reedited as a Java RMI client syntax to call a remote module.

The terminal 100 and the offload server 200 may execute the application in a distributed fashion by executing one code set.

According to another embodiment for the application restructuring, by inserting a separated code into application code with an execution mode as a separated condition, the application may be restructured so that a module is offloaded when the separated condition is satisfied (dynamic offloading).

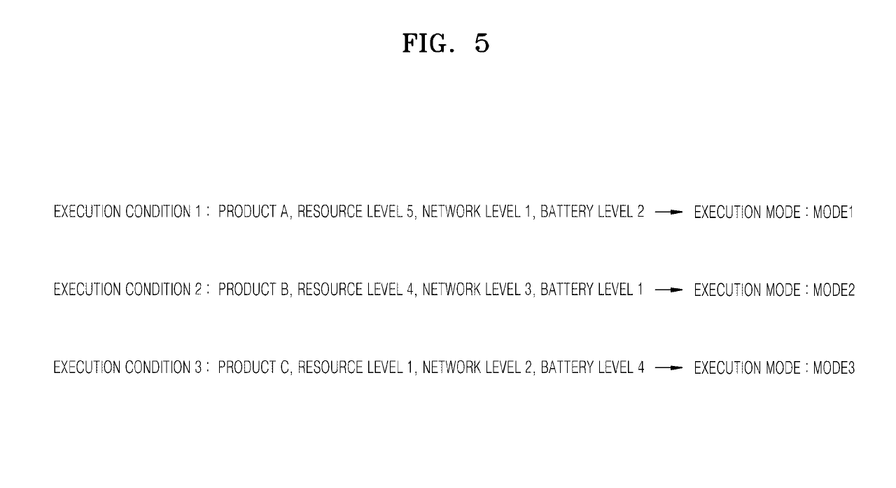

FIG. 5 illustrates definition of an execution mode for dynamic offloading according to an embodiment of the present disclosure.

Referring to FIG. 5, in the execution environment profiling operation S210, a module to be offloaded is determined according to an execution environment condition of the application, and an execution mode corresponding to the execution environment condition is defined. An execution mode is inserted as a separated condition into application code, and a corresponding module may be offloaded by changing an execution mode according to an execution environment during the execution of the application.

For example, in the execution environment profiling operation S210, a module to be offloaded may be determined according to an execution environment condition wherein a terminal product is A, a resource level is 5, a network level is 1, and a battery level is 2, and an execution mode corresponding to the execution environment condition may be defined as an execution mode 1. When an execution environment corresponding to the execution mode 1 occurs during the execution of the application, the terminal 100 may offload a corresponding module by using a separated code.

The application is restructured in the application restructuring operation S230 based on information on a module to be offloaded that corresponds to an execution mode.

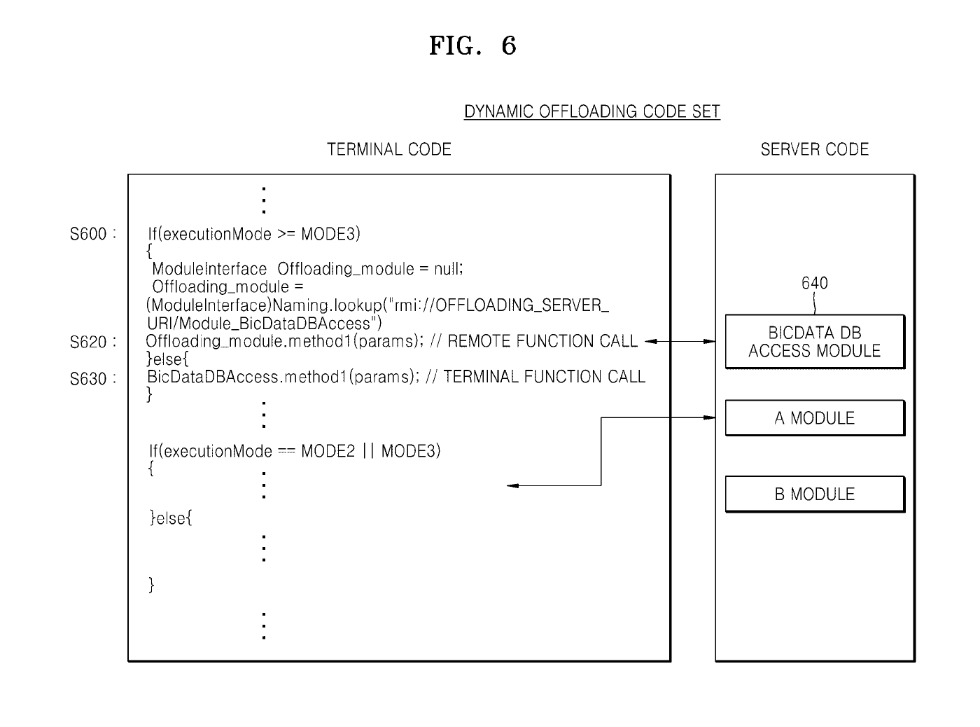

Referring to FIG. 6 illustrates an application code set for dynamic offloading in which a module to be offloaded is changed according to an execution environment during the execution of the application by inserting a separated code according to an embodiment of the present disclosure.

Referring to FIG. 6, it is assumed that an execution mode corresponding to a case where a network state is equal to or less than a reference value is defined as MODE3, MODE4 or above. In addition, it is assumed that a BicDataDBAccess Module 640 shown in FIG. 6 is a module for processing data by accessing a large-capacity DB and has large data traffic with en external device but has small traffic with the other modules. In addition, it is assumed that BicDataDBAccess Module 640 is not only located in the terminal 100 as an original application module but is also offloaded to the offload server 200 through the application restructuring operation S230 to be remotely called by the terminal 100.

In line S600, it is determined whether a current execution mode of the application is MODE3, MODE4 or above.

If the current execution mode is less than MODE3, that is, if a network state is equal to or greater than a reference value, a function of BicDataDBAccess Module 640 that is the original module located in the terminal 100 is called in line S630.

If the current execution mode of the application MODE3, MODE4 or above, that is, if the network state is less than the reference value, a function of the module BicDataDBAccess that is located in the offload server 200 is called in line S620.

A module located in the terminal 100 and the offloaded module may perform an inter-module remote call through RPC or XML-RPC as in static offloading.

As a result, the terminal 100 may change a current execution mode in real-time by monitoring an execution environment during the execution of the application. Thus, an offloading scenario in which the application can be optimally executed in a current execution environment may be selected in real-time.

In addition, since an offloading scenario according to execution environment conditions is constructed so that optimal execution may be performed according to an execution environment through module analysis and profiling before the execution, the application optimized to the execution environment may be executed.

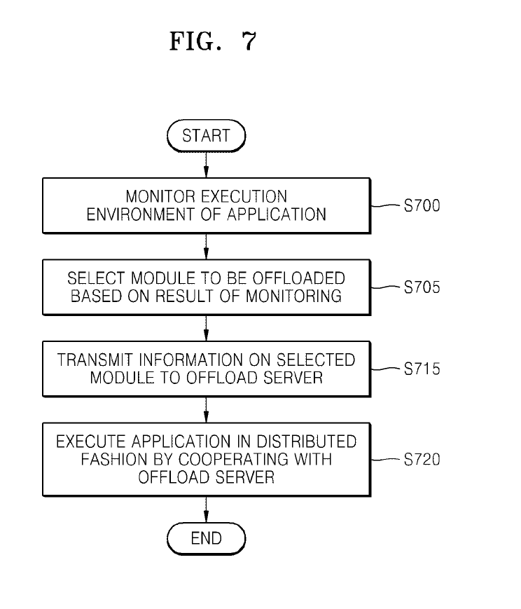

FIG. 7 is a flowchart illustrating a method of executing an application by changing a module to be offloaded according to an execution environment in a terminal according to an embodiment of the present disclosure.

Referring to FIG. 7, the terminal 100 monitors an execution environment of the application in operation S700.

In operation S705, the terminal 100 selects a module to be offloaded based on a result of monitoring the execution environment of the application.

The selecting of the module to be offloaded may include selecting one of a plurality of application code sets generated through a profiling operation. Alternatively, the selecting of the module to be offloaded may include changing an execution mode according to the execution environment monitoring result during the execution of the application.

In operation S715, the terminal 100 transmits information on the selected module to be offloaded to the offload server 200.

In operation S720, the terminal 100 executes the application in a distributed fashion by cooperating with the offload server 200.

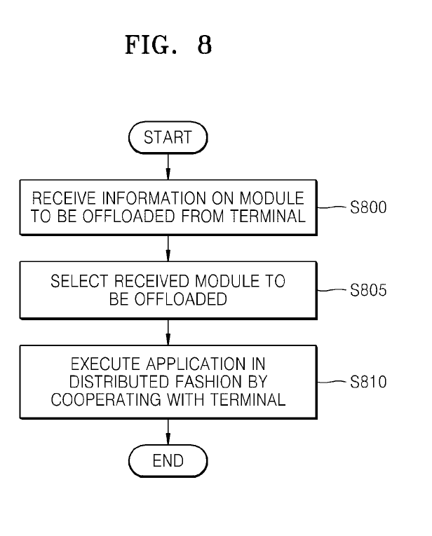

FIG. 8 is a flowchart illustrating a method of executing an offloaded module by cooperating with a terminal in an offload server according to an embodiment of the present disclosure.

Referring to FIG. 8, the offload server 200 receives information on a module to be offloaded from the terminal 100 in operation S800. The information on the module to be offloaded may indicate one of a plurality of application code sets generated through a profiling operation. Alternatively, the information on the module to be offloaded may indicate an execution mode for dynamic offloading.

In operation S805, the offload server 200 selects the module to be offloaded based on the received information. The selecting of the module to be offloaded may include selecting one of a plurality of application code sets. Alternatively, the selecting of the module to be offloaded may include changing an execution mode.

In operation S810, the offload server 200 executes the application in a distributed fashion by cooperating with the terminal 100.

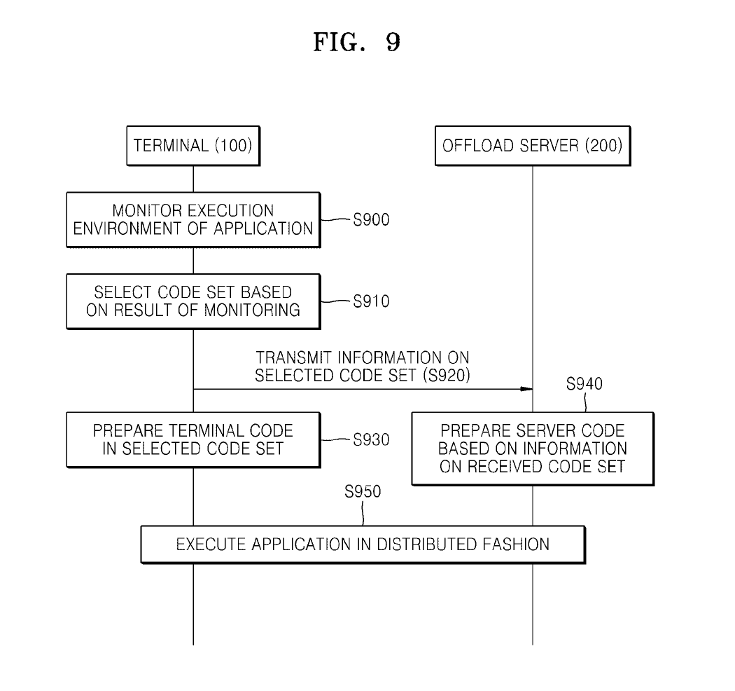

FIG. 9 is a signaling diagram of static offloading in which an application is executed in a distributed fashion by selecting one of a plurality of code sets according to an execution environment according to an embodiment of the present disclosure.

Referring to FIG. 9, the terminal 100 monitors an execution environment of the application before the execution of the application in operation S900.

In operation S910, the terminal 100 selects a code set suitable for a current execution environment from among a plurality of code sets stored in the terminal 100 based on a result of the monitoring.

In operation S920, the terminal 100 transmits information on the selected code set to the offload server 200.

In operation S930, the terminal 100 prepares a terminal code in the selected code set. In the preparation, the terminal 100 may load a code selected from a plurality of code stored in an external memory to an internal memory. Alternatively, the preparation may include preparing inter-module communication so that a module in the terminal 100 can operate as an RPC server.

In operation S940, the offload server 200 prepares an offload server code based on the received code set. In the preparation, the offload server 200 may load a code selected from a plurality of code stored in an external memory to an internal memory. Alternatively, the preparation may include preparing inter-module communication so that an offloaded module can operate as an RPC server. Alternatively, the preparation may include preparing a virtual machine for executing the application.

In operation S950, the terminal 100 and the offload server 200 execute the application in a distributed fashion.

As shown in FIG. 9, since an application code set suitable for a current execution environment is selected by monitoring an execution environment of the application, the application can be optimally executed in a distributed fashion.

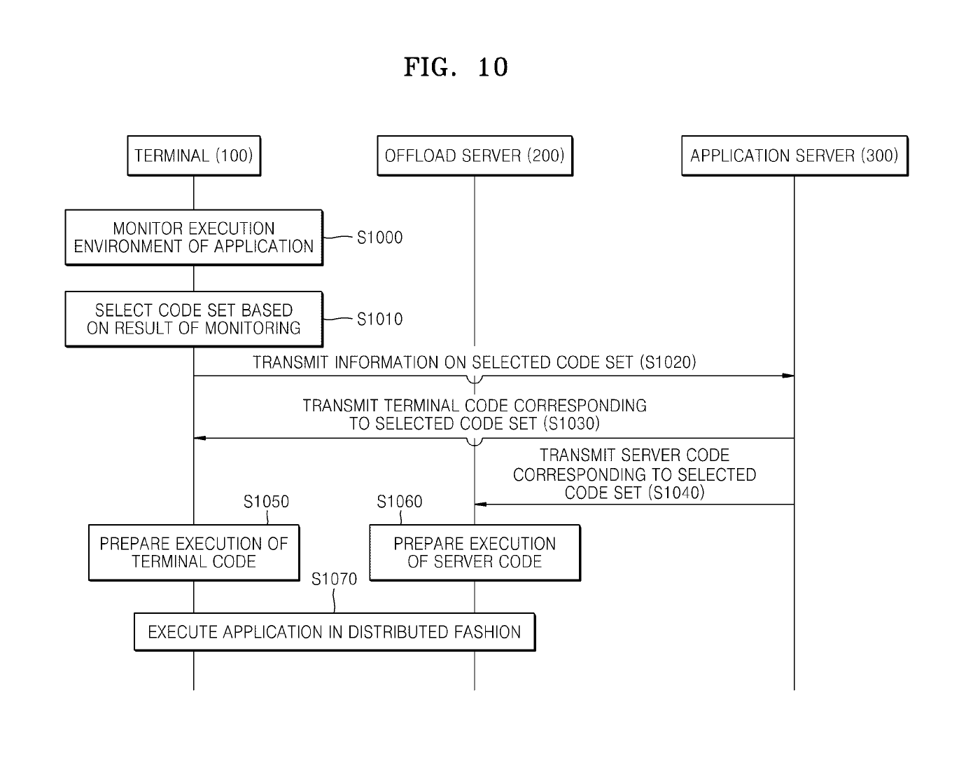

FIG. 10 is a signaling diagram of static offloading in which an application is executed in a distributed fashion by selecting one of a plurality of code sets according to an execution environment according to an embodiment of the present disclosure.

Referring to FIG. 10, one of a plurality of code sets is selected by monitoring an execution environment of the application in operations S1000 and S1010, which thus may correspond to operations S900 and S910 of FIG. 9, respectively.

In operation S1020, the terminal 100 transmits information on the selected code set to an application server 300.

The plurality of code sets of the application may be transmitted from the application server 300 in every execution of the application.

The application server 300 may store the plurality of code sets of the application, receive the information on the selected code set from the terminal 100, and transmit code to be executed to each of the terminal 100 and the offload server 200.

In operation S1030, the application server 300 transmits a code to be executed in the terminal 100 (i.e., terminal code) to the terminal 100 based on the received information on the selected code set.

In operation S1040, the application server 300 transmits a code to be executed in the offload server 200 (i.e., server code) to the offload server 200 based on the received information on the selected code set.

In operations S1050 and S1060, the terminal 100 and the offload server 200 prepare execution of the application. In other words, the terminal 100 prepares execution of the terminal code and the offload server 200 prepares execution of the server code. Thus, operations S1050 and S1060 may correspond to operations S930 and S940 of FIG. 9, respectively.

In operation S1070, the terminal 100 and the offload server 200 execute the application in a distributed fashion, and thus operation S1070 corresponds to operation S950 of FIG. 9.

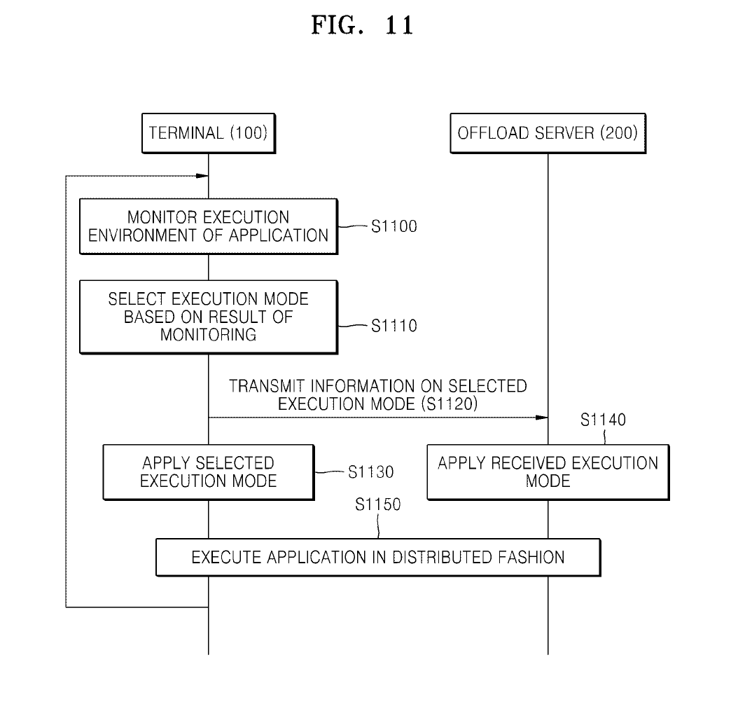

FIG. 11 is a signaling diagram of dynamic offloading in which an application is executed in a distributed fashion by changing an offloaded module according to an execution environment during execution of the application according to an embodiment of the present disclosure.

Referring to FIG. 11, the terminal 100 monitors an execution environment of the application during the execution of the application in a distributed fashion in operation S1100.

In operation S1110, the terminal 100 selects an execution mode corresponding to a current execution environment based on a result of the monitoring.

In operation S1120, the terminal 100 transmits information on the selected execution mode to the offload server 200.

In operation S1130, the terminal 100 applies the selected execution mode while the application is being executed in a distributed fashion.

In operation S1140, the offload server 200 applies the received execution mode while the application is being executed in a distributed fashion.

In operations S1130 and S1140, a value indicating information on an execution mode may be changed to indicate that of a current execution mode while the application is being executed in a distributed fashion. When the execution mode is changed, the terminal 100 and the offload server 200 may change a module to be offloaded according to a separated condition.

In operation S1150, the terminal 100 and the offload server 200 execute the application in a distributed fashion.

The terminal 100 may change an execution mode by continuously monitoring an execution environment during the execution of the application in a distributed fashion.

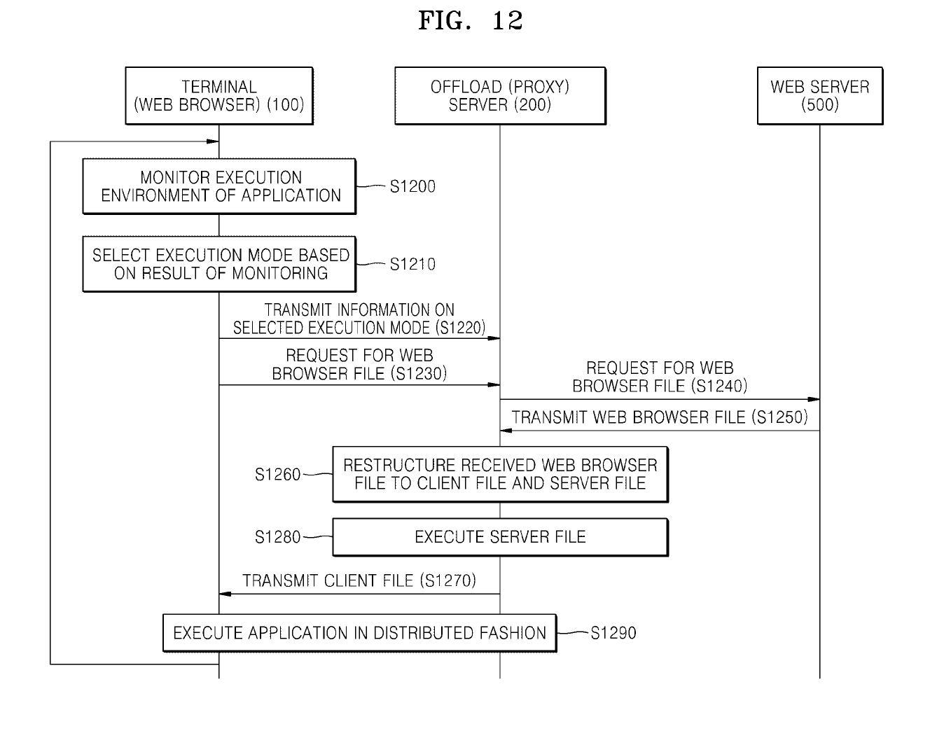

FIG. 12 is a signaling diagram of dynamic offloading in which a web application is executed in a distributed fashion according to an embodiment of the present disclosure.

Referring to FIG. 12, the terminal 100 is a device having a web browser and may execute a web application. A web server 500 is a server for providing a web service to the terminal 100 and may cooperate with a DB storing web content, a web application, and the like or a Web Application Server (WAS). The offload server 200 may be a proxy server, which may store Hypertext Markup Language (HTML), Javascript, images, and Cascading Style Sheets (CSS) files in a cache and transmit a stored file to the terminal when the terminal requests for the stored file.

In operations S1200 and S1210, an execution mode corresponding to a current execution environment is selected based on a result of monitoring, and thus, operations S1200 and S1210 may correspond to operations S1100 and S1110 of FIG. 11, respectively.

In operation S1220, the terminal 100 transmits information on the selected execution mode to the offload server 200. The execution mode may be information on the current execution environment instead of being represented by a predefined value.

In operation S1230, the terminal 100 submits a request to the offload server 200 for a web browser file. The web browser file may be any of all files rendered in a web browser, such as HTML, Javascript, image, and CSS files.

In operation S1240, the offload server 200 submits a request to the web server 500 for the web browser file requested by the terminal 100 when the web browser file requested by the terminal 100 is not stored in the cache.

In operation S1250, the web server 500 transmits the requested web browser file to the offload server 200.

In operation S1260, the offload server 200 restructures the received web browser file to a client file and a server file based on the execution mode received from the terminal 100.

The restructuring of the web browser file may be automatically performed by the proxy server 200. The original web browser file received from the web server 500 may have notations that were inserted during a developing stage for module offloading. Thus, the offload server 200 may restructure the web browser file based on the notations in the web browser file and the execution environment information received from the terminal 100.

For example, the offload server 200 may restructure a module commented on as being a high-load module to a server file when the received execution mode indicates that resources of the terminal 100 are lacking.

The web browser file received from the web server 500 may be a Javascript file. The client file is separately restructured so that it may be linked to an offloaded module. The separated client file is restructured with a server programming language, such as Node.js or JSP.

The client file and the server file may communicate with each other by using an RPC or XML-RPC method. For example, the server file may be restructured so that a module to be offloaded operates as a server for XML-RPC, and the client file may be restructured to remotely call the module to be offloaded by using an implementation of the XML-RPC.

In operation S1280, the offload server 200 executes the server file so that the terminal 100 can remotely call an offloaded module. The offload server 200 may operate as a server for the terminal 100.

In operation S1270, the client file is transmitted to the terminal 100.

In operation S1290, the terminal 100 executes the web application by rendering the received client file. When the offloaded module is being executed during the rendering of the client file, the offloaded module may be remotely called.

The terminal 100 may submit a request to the offload server 200 for a new web browser file and may continuously monitor an application execution environment.

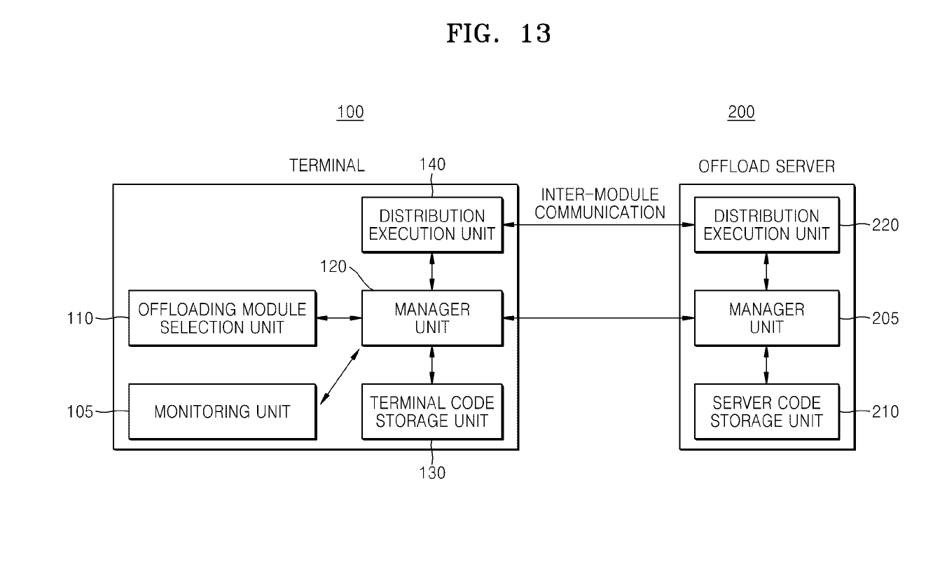

FIG. 13 is a block diagram of a terminal and an offload server for executing an application in a distributed fashion by offloading an application module according to an embodiment of the present disclosure.

Referring to FIG. 13, in the terminal 100, a monitoring unit 105 monitors an execution environment of the application. The monitoring unit 105 may monitor the execution environment not only before execution of the application but also during the execution.

An offloading module selection unit 110 selects a module to be offloaded by referring to a result of the monitoring. The offloading module selection unit 110 may select one of a plurality of application code sets restructured through the execution environment profiling operation S210 before the execution of the application or select one of execution modes derived through the execution environment profiling operation S210.

A manager unit 120 may transmit information on the module to be offloaded, which is selected by the offloading module selection unit 110, to the offload server 200 and may control the monitoring unit 105, the offloading module selection unit 110, a terminal code storage unit 130, and a distribution execution unit 140.

The terminal code storage unit 130 stores terminal codes in a plurality of static offloading code sets. The terminal code storage unit 130 may be an external memory.

The distribution execution unit 140 executes the application by cooperating with the offload server 200. The distribution execution unit 140 may change a module to be offloaded by applying in real-time an execution mode changed according to the monitoring result during the execution of the application.

In the offload server 200, a server code storage unit 210 stores server codes in the plurality of static offloading code sets. The server code storage unit 210 may be an external memory or an external server.

A manager unit 205 receives the information on the module to be offloaded from the terminal 100. The manager unit 205 determines whether the received module to be offloaded is stored in the server code storage unit 210 and prepares execution of the received module. The manager unit 205 controls the server code storage unit 210 and a distribution execution unit 220.

The distribution execution unit 220 executes the application by cooperating with the terminal 100. The distribution execution unit 220 may include a virtual machine to execute various types of applications.

It should be understood that the various embodiments described therein should be considered in a descriptive sense only and not for purposes of limitation. Descriptions of features or aspects within each embodiment should typically be considered as available for other similar features or aspects in other various embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of executing an application in a terminal in a distributed fashion, the method comprising:
monitoring an execution environment of the application selecting a module to be offloaded based on a result of the monitoring;
transmitting information on the selected module to an offload server; and
executing the application in a distributed fashion by cooperating with the offload server.

2. The method of claim 1, wherein the application is an application executable in a distributed fashion, which comprises restructured according to at least one execution environment condition by profiling the same application under the at least one execution environment condition and referring to a result of the profiling.

3. The method of claim 2, wherein the at least one execution environment condition includes at least one of a hardware specification, a software specification, a battery state, a network state, and a resource state of the terminal.

4. The method of claim 2, wherein the executing of the application in a distributed fashion comprises executing one of two or more code sets separated based on the result of the profiling.

5. The method of claim 2, wherein the application comprises an application code set in which at least one execution mode is determined according to the at least one execution environment condition by referring to the result of the profiling, and a separated code for offloading a module by setting the at least one execution mode as a separated condition is inserted.

6. The method of claim 5, wherein the selecting of the module to be offloaded comprises selecting one of the at least one execution mode.

7. The method of claim 5, wherein the offloading of the module comprises identifying a notation in the result of the profiling that is used as information for determining whether the module is to be offloaded.

8. A method of executing an application in a server in a distributed fashion, the method comprising:
receiving information on a module to be offloaded from a terminal;
selecting the module to be offloaded based on the received information; and
executing the application in a distributed fashion by cooperating with the terminal.

9. The method of claim 8, wherein the application comprises an application executable in a distributed fashion, which is restructured according to at least one execution environment condition by profiling the same application under the at least one execution environment condition and referring to a result of the profiling.

10. The method of claim 9, wherein the executing of the application in a distributed fashion comprises executing one of two or more code sets separated based on the result of the profiling.

11. A terminal for executing an application in a distributed fashion, the terminal comprising:
a monitoring unit configured to monitor an execution environment of the application;
an offloading module selection unit configured to select a module to be offloaded based on a result of the monitoring;
a manager unit configured to transmit information on the selected module to an offload server; and
a distribution execution unit configured to execute the application in a distributed fashion by cooperating with the offload server.

12. The terminal of claim 11, wherein the application comprises an application executable in a distributed fashion, which is restructured according to at least one execution environment condition by profiling the same application under the at least one execution environment condition and referring to a result of the profiling.

13. The terminal of claim 11, wherein the at least one execution environment condition includes at least one of a hardware specification, a software specification, a battery state, a network state, and a resource state of the terminal.

14. The terminal of claim 12, further comprising a terminal code storage unit configured to store application codes,
wherein the distribution execution unit executes one of two or more code sets separated based on the result of the profiling.

15. The terminal of claim 12, wherein the application comprises an application code set in which at least one execution mode is determined according to the at least one execution environment condition by referring to the result of the profiling, and a separated code for offloading a module by setting the at least one execution mode as a separated condition is inserted.

16. The terminal of claim 15, wherein the offloading module selection unit selects one of the at least one execution mode.

17. A server for executing an application in a distributed fashion, the server comprising:
a manager unit configured to receive information on a module to be offloaded from a terminal and to select the module to be offloaded based on the received information; and
a distribution execution unit configured to execute the application in a distributed fashion by cooperating with the terminal.

18. The server of claim 17, wherein the application comprises an application executable in a distributed fashion, which is restructured according to at least one execution environment condition by profiling the same application under the at least one execution environment condition and referring to a result of the profiling.

19. The server of claim 18, further comprising a server code storage unit configured to store application codes,
wherein the distribution execution unit executes one of two or more code sets separated based on the result of the profiling.

20. A non-transitory computer-readable storage medium having stored therein program instructions, which when executed by a computer, perform the method of claim 1.
